(19) United States
(12) Patent Application Publication
(10) Pub. No.: US 2024/0190325 A1
(43) Pub. Date: Jun. 13, 2024

(54) Automated Bed Lowering System and Method with Tilt Detection and Tip-over Prevention

(71) Applicant: Intellectual Property Group, LLC, Dunn, NC (US)

(72) Inventor: James Patrick Godwin, JR., Dunn, NC (US)

(21) Appl. No.: 18/587,322

(22) Filed: Feb. 26, 2024

Related U.S. Application Data
(63) Continuation-in-part of application No. 17/840,197, filed on Jun. 14, 2022.

(51) Int. Cl. B60P 1/28

(52) U.S. Cl. CPC B60P 1/283

(57) ABSTRACT

A computerized control system controls a hydraulic subsystem of an articulated dump truck. Among other possible equipment, the hydraulic subsystem controls the raising and lowering of the dump truck bed. The control system detects a side-to-side lean angle of the dump truck. Upon the dump truck leaning at or above a predetermined lean angle, the control system controls the hydraulic subsystem to automatically lower the dump truck bed. In various aspects, the predetermined lean angle may be preprogrammed, may be programmable by the truck operator, or may be programmable only by certain personnel (e.g., changing the lean angle may require entry of a password). In one aspect, a manual override switch prevents automatic lowering of the dump truck bed when the dump truck is leaning at or above the predetermined lean angle.

This application is a Continuation-In-Part of U.S. patent application Ser. No. 17/840,197, filed 14 Jun. 2022, titled “Automated Speed-Triggered Bed Lowering System and Method with Manual Override.”

### FIELD OF INVENTION

The present invention relates generally to articulated dump trucks, and in particular to a system and method of automatically lowering a raised bed of a dump truck if the truck is leaning excessively to one side and is in danger of a tip-over.

### BACKGROUND

The global market for dump trucks in 2022 was $8.1B, and is projected to increase to $15B by 2030. Dump trucks are used in mining, construction, waste management, snow and ice removal, and other industries. Growth in the dump truck market is driven by increased exploration in the mining industry, and renewed (post-COVID) investment in transportation infrastructure and industrial, commercial, and residential building construction. Investment in new dump trucks is required to meet stringent emissions and other environmental controls, and to take advantage of technological advances.

One such technological advance is computer control of mechanical and hydraulic systems, which have conventionally been controlled manually. U.S. Patent Application Publication 2021/0156098, the disclosure of which is incorporated herein by reference in its entirety, describes a computerized control system, which may be implemented in a tablet computer or other similar controls, for driving a hydraulic subsystem and other equipment, such as a sand/salt spreader. The hydraulic subsystem may, in turn, drive equipment such as the articulated bed of a dump truck, a snowplow, or the like. Among other innovations, the '098 patent publication describes the significant safety advance of controlling the system via steering-wheel mounted buttons, allowing the operator to keep his or her eyes on the road.

U.S. patent application Ser. No. 17/840,197 describes a computerized control system that controls the hydraulic subsystem of an articulated dump truck. Among other possible equipment, the hydraulic subsystem controls the raising and lowering of the dump truck bed. The control system detects the speed of the dump truck. Upon the dump truck traveling at or above a predetermined speed, if the dump truck bed is at least partially raised, the control system controls the hydraulic subsystem to automatically lower the dump truck bed, while simultaneously activating a visual/audible alarm. This is a safety feature, which prevents collision with overpasses, bridge superstructures, tree limbs, power lines, and the like.

As the bed of a dump truck is raised, the center of mass of the truck+load rises accordingly. This makes a dump truck more “top-heavy” when the bed is raised than when it is lowered, particularly when the bed is fully loaded, e.g., with gravel, sand, salt, or the like. Conceptually, viewing a dump truck from the front or back, the wheelbase and center of mass form a triangle, with the center of mass at the apex and, when the truck is on a level surface, nominally centered between the wheels. For a vehicle that is tilted to one side, a vertical projection of the center of mass to the ground is no longer centered between the wheels, but is closer to the down-slope wheels. Furthermore, the center of mass moves further to the down-slope side the higher it is raised. A vehicle will roll, or tip over, when its center of mass moves outside its wheelbase. The roll stability of a dump truck thus decreases as its bed raises to dump a load. A dump truck on a sideways slope may be stable with the bed lowered, but raising the bed (and the load) can move the center of mass outside the wheelbase, causing the truck to tip over.

Another tip-over hazard for dump trucks is a soft surface. Due to the nature of mining, construction, waste disposal, and the like, dump trucks often operate off-road, and may encounter soft earth, sand, and the like. If a dump truck is parked on a slope, even if it is stable with the bed lowered, as the bed rises to dump a load, the rising center of mass moves further to one side. The extra weight on the down-slope wheels may cause them to sink down into soft earth, sand, or the like, increasing the tilt of the truck, which may lead to a tip-over.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to aspects of the present disclosure, a computerized control system controls the hydraulic subsystem of an articulated dump truck. Among other possible equipment, the hydraulic subsystem controls the raising and lowering of the dump truck bed. The control system detects the sideways tilt, referred to herein as a lean angle, of the dump truck (lean angle=0 on level surface). If the detected lean angle exceeds a predetermined value, and the dump truck bed is at least partially raised, the control system controls the hydraulic subsystem to automatically lower the dump truck bed, while optionally activating a visual/audible alarm. In various aspects, the predetermined lean angle may be preprogrammed, may be programmable by the truck operator, or may be programmable only by certain personnel (e.g., changing the values may require entry of a password). In one aspect, a manual override prevents automatic lowering of the dump truck bed when the dump truck lean angle exceeds the predetermined lean angle. In one aspect, the manual override feature may be restricted, such as by requiring entry of a password. In one aspect, there is no manual override of automatic lowering of the dump truck bed when the dump truck lean angle exceeds the predetermined lean angle.

One aspect relates to a method of controlling a bed of an articulated dump truck. A lean angle of the dump truck is sensed. A position of the dump truck bed is sensed. The sensed lean angle of the dump truck is compared to a predetermined lean angle. In response to the dump truck bed being at least partially raised and the sensed lean angle of the dump truck equaling or exceeding the predetermined lean angle, the dump truck bed is automatically lowered.

Another aspect relates to a controller configured to control a hydraulic subsystem of a dump truck. The controller includes memory and processing circuitry operatively connected to the memory. The processing circuitry is configured to sense a lean angle of the dump truck; sense a position of the dump truck bed; compare the sensed lean angle of the dump truck to a predetermined lean angle; and in response to the dump truck bed being at least partially raised and the sensed lean angle of the dump truck equaling or exceeding the predetermined lean angle, control the hydraulic subsystem to automatically lower the dump truck bed.

Yet another aspect relates to a method of controlling a bed of an articulated dump truck. A position of the dump truck bed is sensed. A lean angle of the dump truck is sensed. The sensed lean angle of the dump truck is compared to a predetermined lean angle. A speed of the dump truck is sensed. The sensed speed of the dump truck is compared to a predetermined speed. In response to the dump truck bed being at least partially raised and the sensed lean angle of the dump truck equaling or exceeding the predetermined lean angle, the dump truck bed is automatically lowered. In response to the dump truck bed being at least partially raised and the sensed speed of the dump truck equaling or exceeding the predetermined speed, the dump truck bed is automatically lowered.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1A depicts an articulated dump truck with the bed lowered.

FIG. 1B depicts an articulated dump truck with the bed raised.

FIG. 2 is a block diagram of a control system for a dump truck.

FIG. 3 is a flow diagram of a method of controlling a bed of a dump truck in response to a sensed lean angle of the dump truck.

FIG. 4 is a flow diagram of a method of controlling a bed of a dump truck in response to both a sensed lean angle and a sensed seed of the dump truck.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

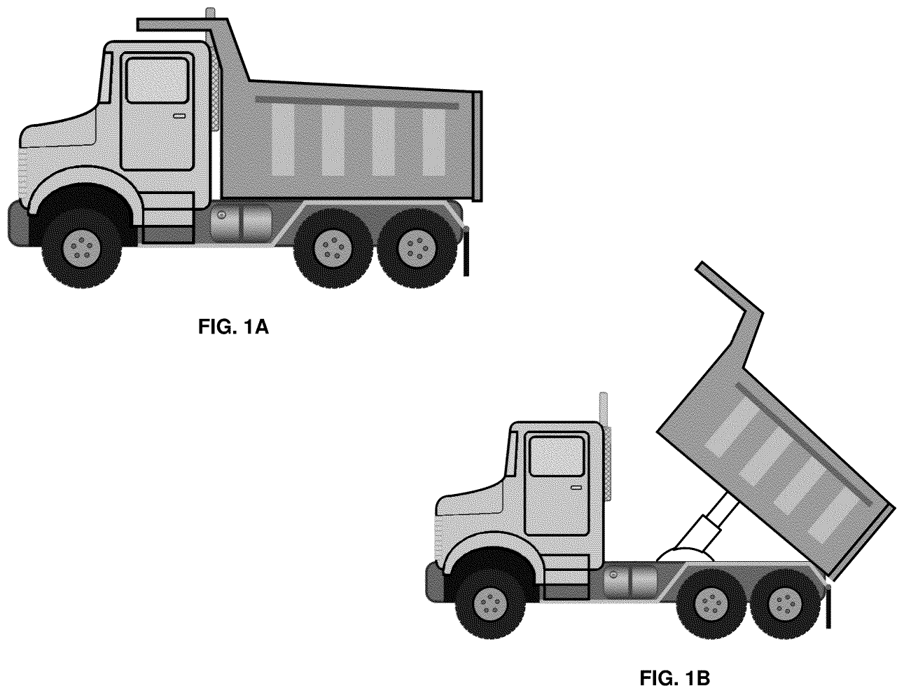

FIG. 1A depicts an articulated dump truck with the bed lowered. This is the dump truck bed's normal position, in which the dump truck transports material contained in the bed. FIG. 1B depicts the dump truck bed in a raised position. The raised position is normally only used to discharge, or “dump,” the truck's load. The dump truck and load together have a higher center of mass when the bed is in the raised position, than when it is lowered. Raising the bed of a dump truck, particularly when it carries a load, decreases the roll stability of the dump truck. Accordingly, raising the bed when the truck has sideways lean, or is on a soft surface, presents a safety hazard.

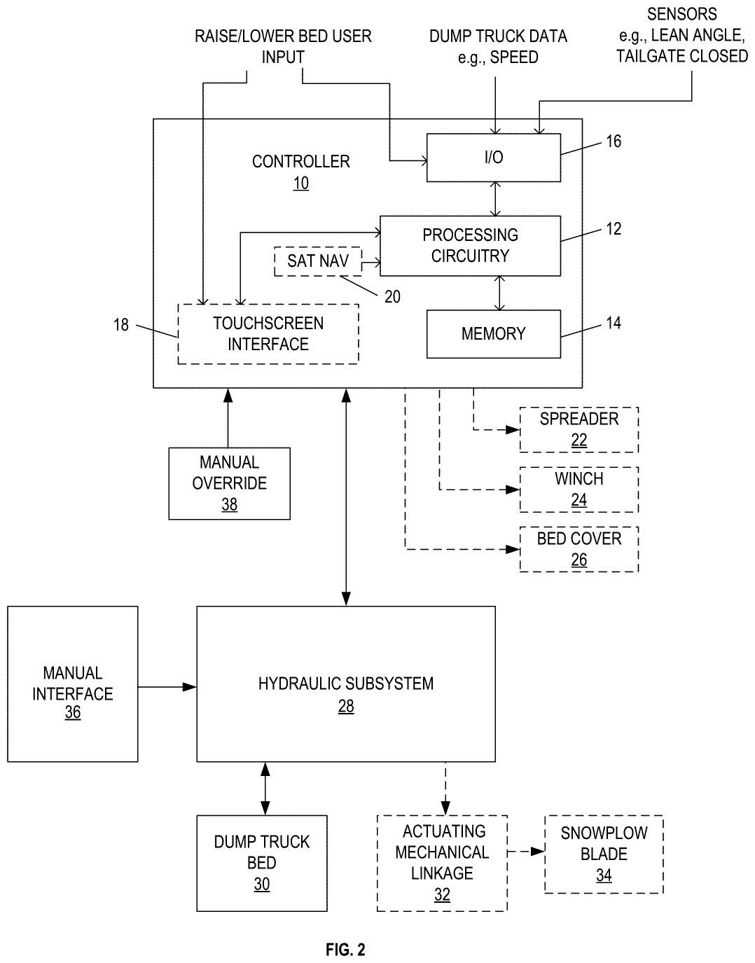

FIG. 2 depicts a block diagram of a control system for a dump truck, according to aspects of the present disclosure. The system includes a computerized controller 10, which may for example be implemented with a tablet computer, integrated into the dump truck dashboard, part of the truck chassis computer system, or the like. The controller 10 includes processing circuitry 12, non-transitory memory 14, Input/Output (I/O) functionality 16, and optionally (as indicated by dashed lines) a touchscreen user interface 18 and optionally a satellite navigation module 20.

The processing circuitry 12 may comprise one or more hardwired state machines, programmable logic with associated firmware, one or more general purpose microprocessors or Digital Signal Processors with associated software, or any combination of these. The non-transitory memory 14 may comprise register files in the processing circuitry 12, solid state memory (e.g., DRAM, SRAM, SSD, Flash, etc.), optical media (e.g., CD, DVD), magnetic media, or any other type of non-transitory digital media known in the art. Although depicted as internal to the controller 10, the non-transitory memory 14 may include external data storage, such as an SD card, external disc drive, or the like.

The I/O functionality 16 is configured to receive certain data and parameters from the dump truck, such as the truck's speed, whether it is in gear, and the like. As non-limiting examples, the I/O 16 may connect to an OnBoard Diagnostics (OBD) port of the dump truck, may comprise a node on a Controller Area Network (CAN) bus, or the like. In some aspects, the I/O functionality 16 may not connect to a port or bus of the dump truck. The I/O functionality 16 is further configured to receive data from one or more sensors installed in or added to the dump truck, such as a lean angle sensor, a tailgate closed sensor, and the like. In particular, one or more lean angle sensors are installed on the dump truck at appropriate locations, and connected to the controller 10. The lean angle sensor(s) is preferably installed, and/or calibrated, such that it outputs a value of or near zero when the truck is on a level surface (and/or the controller 10 compensates the sensor reading such that a level surface output is known). Vehicle lean angle sensors are well known in the art; for example, they are installed on many off-road vehicles and motorcycles to sense a roll-over or lay-down, respectively, and kill the engine.

The I/O 16 may additionally receive user input to raise or lower the dump truck bed, such as by a user pressing a rocker switch, or separate switches for the two functions. In one aspect, these switches may be located on the dump truck steering wheel, and may swap functionality between dump truck bed raise/lower input and conventional input (such as audio system control, cruise control, or the like), as described in the above-incorporated '098 patent publication. The user may additionally, or alternatively, input dump truck bed raise/lower commands via the touchscreen interface 18 of the controller 10.

In some aspects, the controller 10 may optionally (as indicated by dashed lines) control accessories and aftermarket equipment installed on the dump truck. Examples include a sand/salt spreader 22 on a dump truck configured as a snowplow; a winch 24; an automated bed cover 26; or other equipment.

The controller 10 controls a hydraulic subsystem 28. The hydraulic subsystem 28 controls raising and lowering of the dump truck bed 30. As indicated by double-headed arrows on the lines between the controller 10 and the dump truck bed 30 (via hydraulics subsystem 28), commands flow from the controller 10 to cause the dump truck bed 30 to raise and lower, and sensor data flows from the dump truck bed 30 (and hydraulics subsystem 28) to the controller 10, reporting at least the position of the dump truck bed 30. In some aspects (as indicated by dashed lines), the hydraulic subsystem 28 may additionally control hydraulic accessories and hydraulic aftermarket equipment installed on the dump truck, such as an actuating mechanical linkage 32 that controls the height, angle, and the like of a snowplow blade 34. The hydraulic subsystem 28 may additionally have a legacy manual interface 36.

A manual override switch 38, the purpose and function of which is described in greater detail herein, may be connected to the controller 10. Alternatively, in some aspects, the touchscreen interface 18 may display, and accept user actuation of, an override indication.

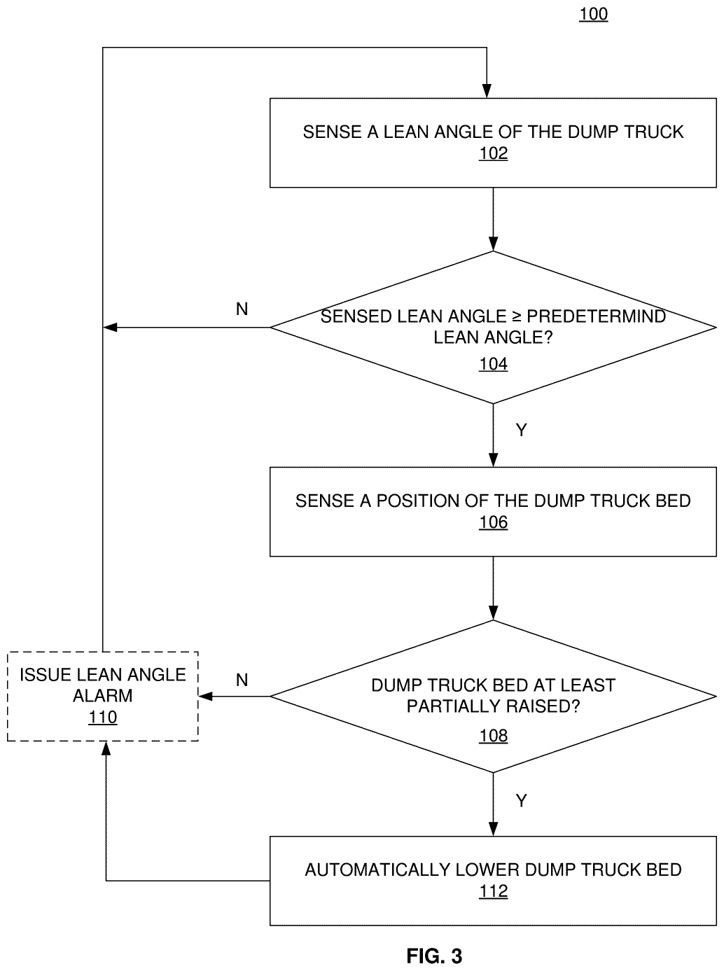

FIG. 3 depicts the steps in a method 100 performed by the controller 10, according to aspects of the present disclosure, in which the controller 10 controls the hydraulic subsystem 28 to automatically lower the dump truck bed if it is at least partially raised and the dump truck is leaning to one side at or greater than a predetermined lean angle. In particular, the controller 10 continuously or periodically senses a lean angle of the dump truck (block 102). For example, the controller 10 receives data from one or more lean sensors installed on the dump truck.

The controller 10 compares the sensed lean angle of the dump truck to the predetermined lean angle (block 104). If the sensed lean angle is less than the predetermined lean angle, the method 100 returns to monitoring the lean angle. Initially, the dump truck may be level, or have only a slight tilt. In this case, at block 104, the method will return to sensing the lean angle at block 102. If the lean angle changes—for example, if one side of the dump truck sinks into sand or soft earth as the bed is raised—to the point that it exceeds the predetermined lean angle, this will be detected by the loop-back to block 102 and comparison at block 104. If, at any time, the sensed lean angle equals or exceeds the predetermined lean angle, the controller 10 senses a position of the dump truck bed (block 106). For example, the controller 10 may read the dump truck bed position from the hydraulic subsystem 28.

If the dump truck bed is fully lowered (block 108), the method 100 may optionally (as indicated by dashed lines) issue a visible and/or audible alarm that the dump truck is leaning dangerously (block 110). The method 100 then loops back to block 102 where it continues to monitor the lean angle. However, if the dump truck bed is at least partially raised (block 108), the controller 10 controls the hydraulic subsystem 28 to automatically lower the dump truck bed to the fully lowered position (block 110). During this actuation of the dump truck bed, the controller 10 may optionally issue a lean angle alarm, (block 110), indicating that the dump truck is leaning greater than the predetermined lean angle with the dump truck bed raised, and that the bed is being lowered. Those of skill in the art will readily recognize that the steps of method 100 may be performed in a different order than depicted in FIG. 3. For example, the controller 10 may continuously monitor the position of the dump truck bed (blocks 106, 108), and only read the lean angle sensor (block 102) when the bed is partially raised. In some aspects, both the dump truck bed position and the lean angle sensor are continuously or periodically monitored.

The predetermined lean angle may be stored in memory 14. In some aspects, the predetermined lean angle is configured at the factory (or dump truck customization shop) prior to delivery, and cannot be changed. In other aspects, the predetermined lean angle may be changed in the field, but the ability to change it is limited to authorized personnel, such as a field supervisor or fleet manager. In this case, changing the predetermined lean angle may be password-protected. That is, a user attempting to change the predetermined lean angle is prompted to enter a password, and the predetermined lean angle is only changed if the password is verified. In some aspects, the predetermined lean angle may be changed by any user (or, upon verifying the password, the password verification itself may be disabled), as may be appropriate for a dump truck sold to an independent owner/operator.

In some aspects, a manual override 38 is provided. The manual override 38 may comprise a button on the steering wheel or dashboard, a footswitch, a lever, touch screen technology, a button on a joystick or control yoke, or any other form of input. When the manual override 38 is actuated, the automated lowering of the dump truck bed is suspended. This allows a user to knowingly raise the bed with the dump truck on a side slope. For safety, in some aspects, the manual override 38 operates as a “dead man switch”—that is, it must be continuously actuated for the override function to take effect. If the manual override 38 is released, and the controller 10 senses the truck lean angle is at or greater than the predetermined lean angle, then it will automatically lower the dump truck bed. In some aspects, the controller 10 may be programmed to disregard the manual override 38, thus making the safety feature of automatically lowering the dump truck bed one that cannot be overridden or circumvented in any manner.

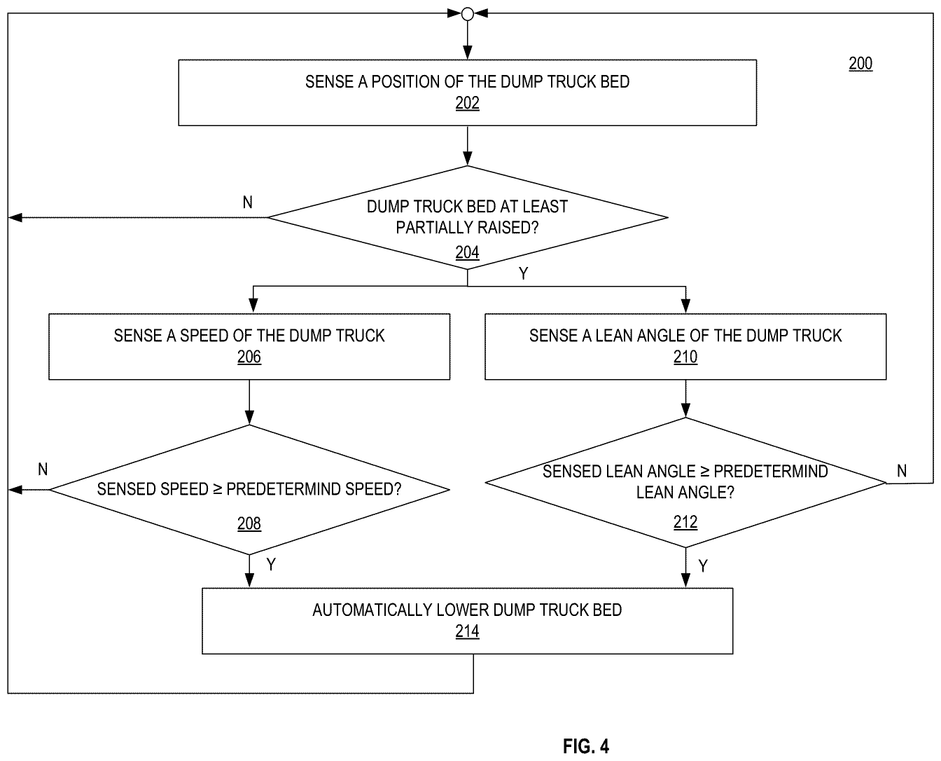

FIG. 4 depicts a method 200 of automatically lowering a dump truck bed in response to either exceeding a predetermined speed, as described in U.S. patent application Ser. No. 17/840,197, or the dump truck lean angle exceeding a predetermined lean angle, as described above. A controller 10 installed in a dump truck may separately implement the method 100 of the '197 application and the method 100 of FIG. 3. Alternatively, the controller 10 may implement the method 200, which merges the functionality of the two methods.

The controller 10 periodically or continuously senses a position of the dump truck bed (block 202). For example, the controller 10 may read the dump truck bed position from the hydraulic subsystem 28. If the dump truck bed is in the fully lowered position (block 204), the controller 10 continues to monitor the dump truck bed position (block 202). On the other hand, if the dump truck bed is at least partially raised (block 204), the controller 10 senses a speed of the dump truck (block 206). For example, the controller 10 may obtain the speed from the I/O function 16, which may be connected to a CAN bus or other bus, or may monitor the dump truck OBD port. The I/O function 16 may read the dump truck speed directly, or the processing circuitry 12 may estimate the speed from other data, such as engine speed and gear, tire rotation speed, or the like. Alternatively, the controller 10 may obtain the dump truck speed from an integrated satellite navigation module 20 as shown in FIG. 2, or from an external satellite navigation module via the I/O function 16. The controller 10 compares the sensed speed of the dump truck to the predetermined speed (block 208). If the sensed speed is less than the predetermined speed, the method 200 returns to monitoring the position of the dump truck bed (block 202) and, if it is at least partially raised (block 204), the dump truck speed (block 206). However, if the sensed speed equals or exceeds the predetermined speed (block 208), the controller 10 controls the hydraulic subsystem 28 to automatically lower the dump truck bed to the fully lowered position (block 214). During this actuation of the dump truck bed, the controller 10 may optionally issue a warning, in the form of a visual and/or audible alarm, that the dump truck is in motion greater than the predetermined speed with the dump truck bed raised, and that the bed is being lowered.

If the dump truck bed is in an at least partially raised position (block 204), the controller 10 additionally senses a lean angle of the dump truck (block 210). The controller 10 compares the sensed lean angle of the dump truck to the predetermined lean angle (block 212). If the sensed lean angle is less than the predetermined lean angle, the method 200 returns to monitoring the position of the dump truck bed (block 202) and, if it is at least partially raised (block 204), the dump truck lean angle (block 210). However, if the sensed lean angle equals or exceeds the predetermined lean angle (block 212), the controller 10 controls the hydraulic subsystem 28 to automatically lower the dump truck bed to the fully lowered position (block 214). During this actuation of the dump truck bed, the controller 10 may optionally issue a warning, in the form of a visual and/or audible alarm, that the dump truck is leaning at an angle greater than the predetermined lean angle with the dump truck bed raised, and that the bed is being lowered.

Those of skill in the art will readily recognize that the specific order of steps in method 200 depicted in FIG. 4 is exemplary only, and not limiting. In general, the controller 10 may sense the position of the dump truck bed (block 202), dump truck speed (block 206) and dump truck lean angle (block 210) continuously, or periodically in rapid succession. The controller 10 may make comparisons and determinations (blocks 204, 208, 212) contemporaneously with the sensing steps. Accordingly, any causality implied by the order of method steps in FIG. 4 (e.g., dump truck speed is only sensed if the dump truck bed is at least partially raised) is not a limitation of aspects of the present disclosure. In other words, the controller 10 will automatically lower the dump truck bed if it is at least partially raised AND the dump truck sensed speed equals or exceeds the predetermined speed OR the dump truck sensed lean angle equals or exceeds the predetermined lean angle (or both conditions are true)—regardless of the order in which the sensing and comparison steps are performed.

Aspects of the present disclosure present numerous advantages over the prior art. By automatically lowering the dump truck bed whenever the dump truck is leaning in excess of a predetermined lean angle with the bed at least partially raised, the risk of tip-over is reduced or eliminated. Because the hydraulics subsystem 28 is directly controlled by a computerized controller 10, a user cannot disable or circumvent the safety feature of automatically lowering the dump truck bed. In some aspects, the predetermined lean angle that triggers automatic lowering of the dump truck bed is user-configurable. In some aspects, a manual override 38 allows for limited bypass of the safety feature of automatic dump truck bed lowering. Both of these configuration options may be password-protected, providing organizations with flexibility in setting and enforcing the safety protocols.

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A method of controlling a bed of an articulated dump truck, comprising:
sensing a lean angle of the dump truck;
sensing a position of the dump truck bed;
comparing the sensed lean angle of the dump truck to a predetermined lean angle; and
in response to the dump truck bed being at least partially raised and the sensed lean angle of the dump truck equaling or exceeding the predetermined lean angle, automatically lowering the dump truck bed.

2. The method of claim 1 further comprising, in response to the dump truck bed being at least partially raised and the sensed lean angle of the dump truck equaling or exceeding the predetermined lean angle, emitting a warning.

3. The method of claim 1 further comprising:
sensing actuation of a manual override switch; and
in response to the dump truck bed being at least partially raised and the sensed lean angle of the dump truck equaling or exceeding the predetermined lean angle and the manual override switch is actuated, refraining from automatically lowering the dump truck bed.

4. The method of claim 3 wherein sensing actuation of a manual override switch is ongoing, and wherein the manual override switch must remain actuated to refrain from automatically lowering the dump truck bed.

5. The method of claim 3 further comprising:
sensing that the manual override switch is not actuated; and
in response to the dump truck bed being at least partially raised and the sensed lean angle of the dump truck equaling or exceeding the predetermined lean angle, automatically lowering the dump truck bed.

6. The method of claim 1 further comprising:
sensing user input; and
changing the predetermined lean angle in response to user input.

7. The method of claim 6 further comprising, in response to user input to change the predetermined lean angle:
receiving a password;
verifying the password; and
wherein changing the predetermined lean angle in response to user input comprises changing the predetermined lean angle only if the password is verified.

8. A controller configured to control a hydraulic subsystem of a dump truck, comprising:
memory; and
processing circuitry operatively connected to the memory, and configured to
sense a lean angle of the dump truck;
sense a position of the dump truck bed;
compare the sensed lean angle of the dump truck to a predetermined lean angle; and
in response to the dump truck bed being at least partially raised and the sensed lean angle of the dump truck equaling or exceeding the predetermined lean angle, control the hydraulic subsystem to automatically lower the dump truck bed.

9. The controller of claim 8 wherein the processing circuitry is further configured to, in response to the dump truck bed being at least partially raised and the sensed lean angle of the dump truck equaling or exceeding the predetermined lean angle, emitting a warning.

10. The controller of claim 8 wherein the processing circuitry is further configured to:
sense actuation of a manual override switch; and
in response to the dump truck bed being at least partially raised and the sensed speed of the dump truck equaling or exceeding the predetermined speed and the manual override switch is actuated, control the hydraulic subsystem to refrain from automatically lowering the dump truck bed.

11. The controller of claim 10 wherein the processing circuitry is configured to continuously sense actuation of the manual override switch, and wherein the manual override switch must remain actuated to refrain from controlling the hydraulic subsystem to automatically lower the dump truck bed.

12. The controller of claim 10 wherein the processing circuitry is further configured to:
sense that the manual override switch is not actuated; and
in response to the dump truck bed being at least partially raised and the sensed speed of the dump truck equaling or exceeding the predetermined speed, control the hydraulic subsystem to automatically lower the dump truck bed.

13. The controller of claim 8 wherein the processing circuitry is further configured to:
sense user input; and
change the predetermined speed in response to user input.

14. The controller of claim 13 wherein the processing circuitry is further configured to, in response to user input to change the predetermined speed:
receive a password;
verify the password; and
wherein the processing circuitry is configured to change the predetermined speed in response to user input by changing the predetermined speed only if the password is verified.

15. A method of controlling a bed of an articulated dump truck, comprising:
sensing a position of the dump truck bed;
sensing a lean angle of the dump truck;
comparing the sensed lean angle of the dump truck to a predetermined lean angle;
sensing a speed of the dump truck;
comparing the sensed speed of the dump truck to a predetermined speed; and
in response to the dump truck bed being at least partially raised and the sensed lean angle of the dump truck equaling or exceeding the predetermined lean angle, automatically lowering the dump truck bed; and
in response to the dump truck bed being at least partially raised and the sensed speed of the dump truck equaling or exceeding the predetermined speed, automatically lowering the dump truck bed.
